(19) United States
(12) Patent Application Publication
(10) Pub. No.: US 2022/0266073 A1
(43) Pub. Date: Aug. 25, 2022

(54) Sling Climbing Harness

(71) Applicant: Thomas Calvin Dalziel, Logan, UT (US)

(72) Inventor: Thomas Calvin Dalziel, Logan, UT (US)

(21) Appl. No.: 17/184,844

(22) Filed: Feb. 25, 2021

(51) Int. Cl. A62B 35/00

(52) U.S. Cl. CPC A62B 35/0037

(57) ABSTRACT

The present invention is directed to a sling climbing harness for use in industrial and recreational activities where the climbing harness is worn by a user to securely attach themself to a safety rope or other device. The climbing harness provides a waistbelt and/or leg loops each including one or more adjustable spliced sling loops. Each of the one or more sling loops is a cord having a first end formed into a fixed loop and a second end passing through the fixed loop and spliced into an adjustable loop to form an adjustable locking connection. The user can then adjust each sling loop individually for a custom fitment of the waistbelt or leg loops of the present invention.

### CROSS REFERENCE TO RELATED APPLICATIONS

This application claims benefit of U.S. Provisional Application No. 62/982,059 entitled “SLING CLIMBING HARNESS” and filed Feb. 26, 2020, which is herby incorporated by reference.

### BACKGROUND OF THE INVENTION

### 1. Field of the Invention

The present invention relates to a climbing harness for recreational and industrial activities and more particularly to a lightweight climbing harness that is secured with one or more adjustable spliced sling loops

### 2. Discussion of the Related Art

Many recreational activities, such as mountain, ice, or rock climbing, gymnastics, aerial arts, and other physical activities, require the use of a climbing harness to provide support or protect the participating individual should a fall occur. A climbing harness is typically connected to one or more ropes or lanyards with the other end of the rope or lanyard attached to a stable structure, counterweight, or another individual. Various industries also require the use of a safety harness when the worker is located on an elevated structure; for example, scaffolding, exterior walls, or construction sites.

Early harnesses were fabricated of nylon webbing or leather, or were fashioned with rope or tubular webbing tied around the waist with a square knot, water knot, or other appropriate knot tied at the front to secure the harness to the individual. Modern harnesses include a waistbelt, also known as a swami belt, made of nylon webbing or similar material and padding for encircling the torso and secured in the front with a buckle made of metal or similar weighty material. The waistbelt includes a tie-in loop in the front of the waistbelt. The waistbelt tie-in loop interconnects with a belay loop. The waistbelt tie-in loop is also where a climber ties in to a safety or climbing rope and may connect other climbing devices for attaching ropes and other harness elements.

The belay loop may also interconnect with leg loops. Leg loops may be similar in structure to the waistbelt as they are typically made of nylon webbing and padding and secured with a buckle or other connector. A leg loop may also be a fixed leg loop, which is a simple loop of fixed size and has no belt or attachment for changing the size of the leg loop. A leg loop is secured around each leg for additional support for the weight of the individual providing additional stability and comfort. The leg loops are connected to each other with a cross-piece, which also includes a tie-in point. The leg loop tie-in point is connected to the waistbelt tie-in loop with the belay loop, carabiner, D-ring, or other similar connection.

Attempts to improve the strength of safety harnesses have generally added additional material, shoulder harnesses, and larger buckles making harnesses heavier and more bulky. Nylon webbing is heavy and bar tacking it together adds weight and reduces the strength of the fiber. Webbing is also not very comfortable and is typically covered with foam padding to distribute the weight load. Metal buckles used for adjusting the length of the waistbelt also add weight to the typical harness.

Climbing harness buckles are also typically designed to be double-back or other complex threading type buckles. The complex nature of these types of buckles poses an inherent danger, as well. If a user does not properly thread the webbing through the buckle the connection may not hold properly allowing the harness to loosen or open when it should maintain the connection.

A typical harness also has little to no redundancy. A climber has the waistbelt tie-in loop, belay loop, and leg loop tie-in point for attaching their equipment, such as carabiners, belay devices, or a climbing rope; however, if any one of these attachment points fails the climber can become off balance, fall, or flip out of the harness completely. Any of which could cause serious injury or death.

### SUMMARY OF THE INVENTION

Accordingly the present invention is directed to a safety harness with adjustable spliced sling loops suitable for use in industrial and recreational environments.

The intention of a safety harness is to provide a secure attachment between a user and a safety or belay rope when a user will be at a height in which a fall would otherwise create injury or death or other device used for climbing or support while working. Conventional climbing harnesses use belts of webbing or other belting in which a buckle is attached to one end. The webbing is wrapped around the user and the other end of the webbing is inserted through or into the buckle. The webbing is then tightened to adjust to the user's size.

Similarly, a conventional climbing harness uses webbing to form leg loops that are wrapped around each leg of the user and the ends of the webbing attach with a buckle and adjusted to the size of the user's legs.

The adjustable spliced sling loops of the present invention provide the ability to create a harness with adjustable shoulder straps, waistbelt, leg loops, and other elements with a more specific or custom adjustment to the user. Each sling loop provides its own adjustment and when multiple sling loops are used for each element there are several adjustment points to create a custom adjustment for any user. Each adjustable spliced sling loop may be adjusted specifically to the body at that location providing a more comfortable climbing harness fit. A more comfortable harness also allows for fewer distractions by reducing the need to adjust the harness as it is used.

The climbing harness of the present invention may also be readjusted to the body of the user as the body changes over time. The webbing of a conventional harness tends to stretch as it is used multiple times to conform to the user's body. If the user's body changes the webbing would then need time to again stretch and conform to the user's new shape if it is even able to make the new adjustments as it is used.

In addition to the improved adjustability, the adjustable spliced sling loops create an adjustable locking section by passing a first end of a sling loop through the second end of the sling loop creating a locking section without using a buckle or any other attachment device limiting the number of components needed to create the climbing harness of the present invention. Using fewer components allows for a lighter harness and greater comfort.

Multiple adjustable spliced sling loops also provide multiple attachment points providing enhanced safety. A buckle only provides a single attachment and wear point creating a single failure point should the webbing or buckle wear beyond their limits.

It is therefore an object of the present invention to provide a safety harness having adjustable spliced sling loops to form various adjustable elements of the harness.

It is also an object of the present invention to provide a safety harness that has a waistbelt that adjustably attaches to a user without using a double-back or other of buckle.

It is a further object of the present invention to provide a safety harness that is lightweight and comfortable to use while being strong and reliable.

It is a further object of the present invention to provide a safety harness with improved support of the user's body.

It is a further object of the present invention to provide redundant elements to provide enhanced safety should a part wear or fail.

Embodiments of the present invention disclose a safety harness assembly with one or more adjustable spliced sling loops. A further embodiment comprises a harness assembly with a waistbelt using adjustable spliced sling loops. A further embodiment comprises a harness assembly with leg loops using adjustable spliced sling loops. A further embodiment comprises a harness assembly with a shoulder harness using adjustable spliced sling loops. Another embodiment comprises a harness assembly with adjustment slings interconnecting the waistbelt and leg loops. Further, the adjustable spliced sling loops and adjustment slings are formed by passing one end through themself creating a locking section allowing the adjustable spliced sling loops and adjustment slings to be individually tightened and adjusted as necessary.

These and other features and advantages will be set forth in the description that follows, and in part will be apparent from the description, or may be learned by practice of the invention. The objectives and other advantages of the present invention will be realized and attained by the structure particularly pointed out in the written description and claims hereof, as well as the appended drawings.

It is to be understood that both the foregoing general description and the following detailed description are exemplary and explanatory and are intended to provide furth explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a conventional climbing harness;

FIG. 2 shows a detailed view of an adjustable spliced sling loop in accordance with the present invention;

FIG. 3 shows a front view of a sling climbing harness according to an embodiment of the present invention;

FIG. 4a shows a rear view of a sling climbing harness according to an embodiment of the present invention;

FIG. 4b shows a bisection of the backside of the waistbelt according to an embodiment of the present invention;

FIG. 4c shows a waistbelt to leg loops connection according to an embodiment of the present invention;

FIG. 5 shows a detailed view of the front of the waistbelt and a waist sling divider in accordance with an embodiment of the present invention; and

FIG. 6 shows a detailed view of the front of the leg loop and a leg loop sling divider in accordance with an embodiment of the present invention.

### DETAILED DESCRIPTION OF THE PREFERRED EMBODIMENTS

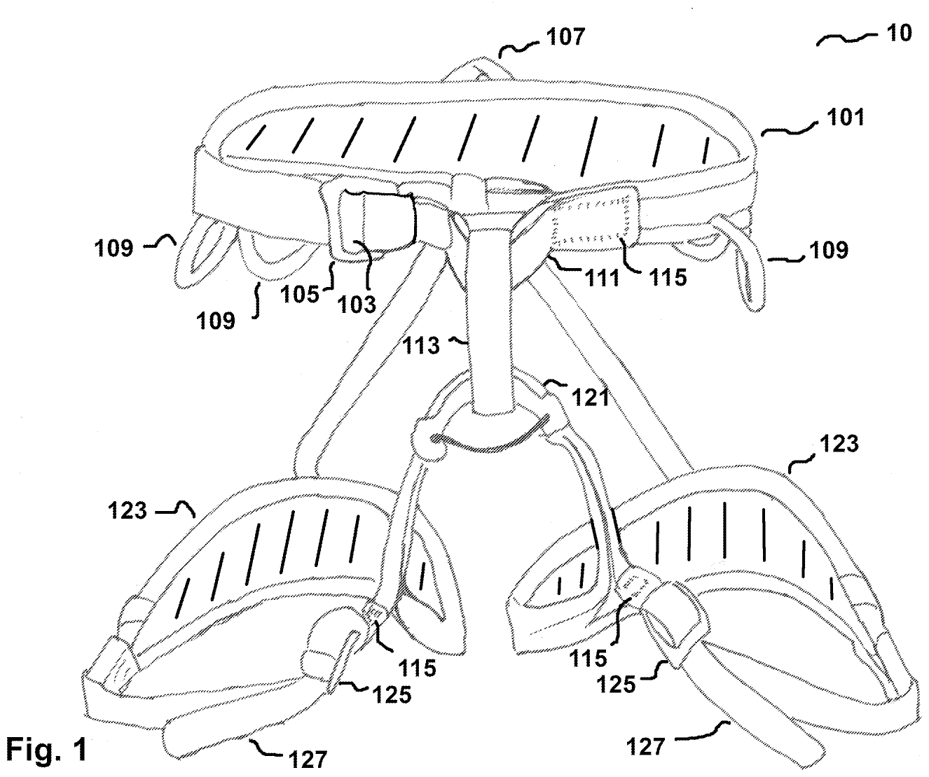

Referring now to the drawings in more detail, FIG. 1 shows a conventional climbing harness 10 comprising a waistbelt 101, a waistbelt closing strap 103, a waistbelt buckle 105, a haul loop 107, gear loops 109, a waistbelt tie-in loop 111, belay loop 113, a leg tie-in point 121, leg loops 123. The conventional harness 10 shown in FIG. 1 further includes leg loop buckles 125, and leg loop closing strap 127. Further versions of a conventional harness 10 may have fixed leg loops without buckles and no apparatus for adjusting the fixed leg loops.

The waistbelt buckle 105 and leg loop buckles 125 of the climbing harness 10 are typically double-back buckles, which may be auto double backing, also known as quick adjust, or manual double backing. Double-back buckles are complex and need significant care to use correctly. With manual double backing, if the webbing is not passed through the buckles properly they may loosen or come undone allowing the waistbelt or a leg loop to come undone while in use. This is also possible with auto double backing but less likely. Nylon webbing through a metal connection, such as the waistbelt buckle 105 and leg loop buckles 125, may also create excessive wear also causing a potential for failure.

Stitching 115 is used to attach the various webbing elements of the waistbelt 101 and leg loops 123, including the tie-in loop 111, the waist buckle 105, and the leg loop buckles 125. Damage from use or abrasion to the stitching 115 can cause the webbing to disconnect from the waistbelt 101 or leg loop 123 and pose a risk of delaminating.

The various embodiments of the present invention provide a climbing harness that is more comfortable, lighter, and safer to use than the conventional climbing harness yet is simple enough that a user of a conventional climbing harness would be able to use the present invention with no or limited additional instruction.

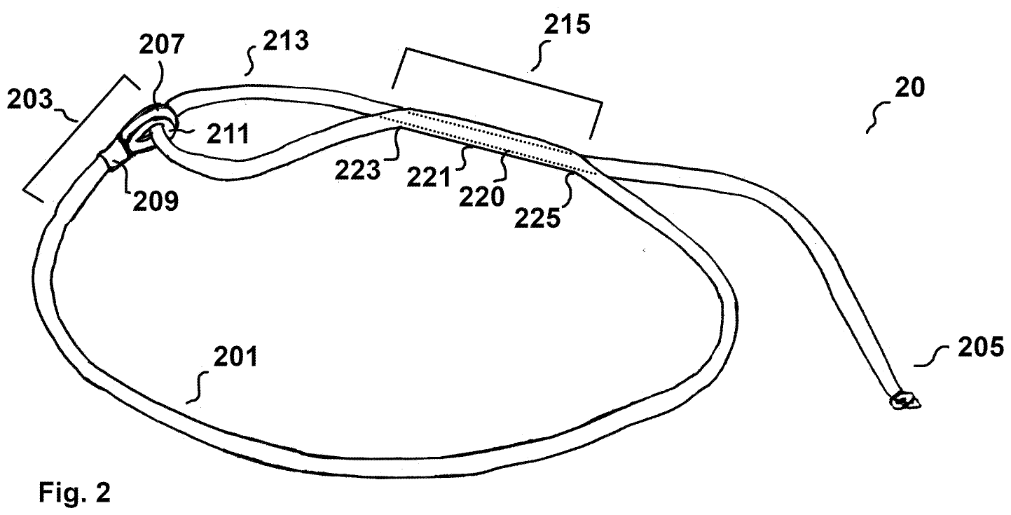

FIG. 2 shows a detailed view of an adjustable spliced sling loop 20 configured for use according to an embodiment of the present invention.

The adjustable spliced sling loop 20 is similar to a modified whoopie sling and comprises a sling cord 201 having a first end 203 and second end 205. The sling cord 201 may be made of any braided cord with an appropriate breaking strength. In a preferred embodiment, the sling cord 201 is made of braided cord made of SK-75 fiber. In a further embodiment, the sling cord 201 is made of braided cord made of SK-78 fiber.

The first end 203 of sling cord 201 is formed into an end loop 207. In a preferred embodiment the loop end 207 is created by passing the first end 203 around a loop-end thimble 211 and spliced with a locking Brummel eye splice. In further embodiments any eye splice may be used. The loop-end thimble 211 may be 3D printed, injection molded, or formed in any other manner in plastic, nylon, or similar material. In a further embodiment the loop-end thimble 211 may be made of vinyl or other tubing, or any other suitable material for wear resistance and smooth operation of the sliding motion of an adjustable loop section 213 of the sling cord 201 through the loop end 207 and loop-end thimble 211.

In a further embodiment a splice cover 209 is added around the splice in the first end 203 and next to the loop-end thimble 211 to provide protection against abrasion as well as a protection against tampering of the splice in the first end 203. The splice cover 209 may be made from heat shrink material of various types, tape, or any other material that may be applied or crimped around the splice of the first end 203 to provide protection.

As mentioned above, in further embodiments the first end 203 may form the loop end 207 by any appropriate splicing method. For example, in one embodiment the loop end 207 may be formed with a simple burying of the first end 203 into sling cord 201 or in a further embodiment the loop end 207 may be formed by laying the first end side-by-side with the sling cord 201 and sewn together. In further embodiments the first end 203 and sling cord 201 may be fused together with heat or adhesive or bound with a binding ferrule to hold the splice.

The adjustable spliced sling loop 20 is further formed by passing the second end 205 through end loop 207 and loop-end thimble 211 to form the adjustable loop section 213. The second end 205 is then threaded through itself by passing the second end 205 into the sling cord 201 and back out to form a sling threaded section 215. The sling threaded section 215 further comprises an internal sling cord section 220 and an external sling cord section 221. The internal sling cord section 220 and the external sling cord section 221 create a sufficient binding force to allow the size of the adjustable spliced sling loop 20 to retain its length when an expansion force is applied.

The sling threaded section 215 further comprises a first end 223 and a second end 225. The sling threaded section 215 may be loosened and adjusted by pushing one or both of the first end 223 or second end 225 of the external sling cord section 221 toward each other; thus reducing the binding force of the sling threaded section 215. In turn, the reduction of binding force allows the internal sling cord section 220 to slide within the external sling cord section 221; thus, adjusting the size of the sling cord 201 without disconnecting sling cord 201. When more than one adjustable spliced sling loop 20 is used the second end 205 of each adjustable spliced sling loop 20 may be connected with a knot, a d-ring, or other connecting device. Connecting devices may be 3D printed, injection molded, or formed in any other manner in plastic, nylon, or similar material.

A climbing harness constructed with adjustable spliced sling loops is stronger and safer than a conventional harness. Strength is further improved with the use of multiple adjustable spliced sling loops 20. Adjustable spliced sling loops 20 may be constructed of any woven or braided cord, including but not limited to SK-70, SK-75, SK-78, SK-90, SK-99, Spectra, Dyneema, Liquid Crystal Polymer, UHMPE (Ultra High Molecular Weight Polyethylene), or the like. In a preferred embodiment adjustable spliced sling loops 20 are constructed from braided cord of ultra high molecular weight polyethylene or high molecular weight polyethylene, such as SK-75 or SK-78 fiber or the like, which is less bulky and much stronger than nylon webbing and other common materials used for conventional climbing harnesses. In a further embodiment the adjustable spliced sling loops 20 are constructed from braided cord of Liquid Crystal Polymer fiber, such as liquid crystal aromatic polyester fiber. Additionally, splicing each sling with itself allows the harness to retain its strength without the need for a buckle or other binding device.

In one embodiment, the use of more than one adjustable spliced sling loop 20 provides redundancy over nylon webbing and other belting. Damage to nylon webbing or any of its attachment points can create a single point of failure causing the waistbelt or leg loop to fail; whereas, any wear or damage to an adjustable spliced sling loop 20 on the waist belt, leg loops, shoulder harness, or other connecting elements is made redundant with additional adjustable spliced sling loops 20 and one failure point will not create a failure in the climbing harness as constructed according to the present invention.

The use of multiple adjustable spliced sling loops 20 allows the harness to be stronger and lighter than a conventional harness. Additionally, double-back buckles and other connecting devices of a typical harness are complex and need significant care to use correctly and may come undone if specific looping of the webbing through the buckle is not done properly. The adjustable spliced sling loops 20 of the present invention are always connected and allow the user to step into the harness and simply tighten the adjustable spliced sling loops 20. The sling interconnection does not allow a harness to come undone when in use or not. To remove the harness a user simply loosens the adjustable spliced sling loops 20 and steps out of the harness; again, without disconnecting the adjustable spliced sling loops 20.

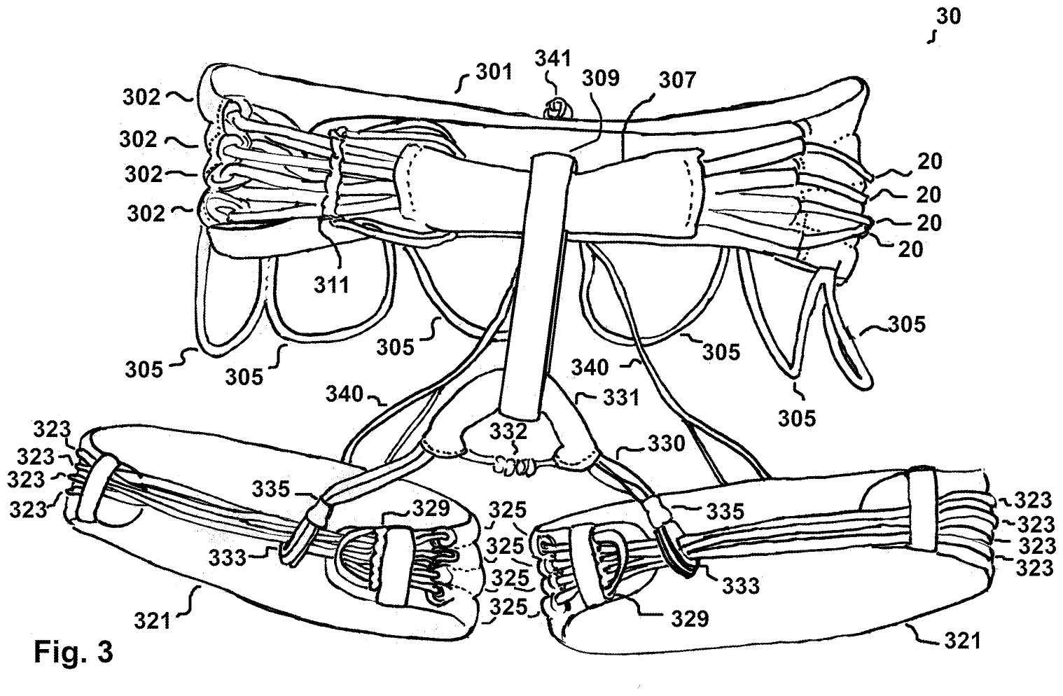

Turning to FIG. 3 a climbing harness 30 according to a preferred embodiment of the present invention is shown. One embodiment of the climbing harness 30 includes a waistbelt 301 comprising one or more sling paths 302, one or more adjustable spliced sling loops 20, one or more gear loops 305, a waistbelt tie-in point 307, a belay loop 309, sling divider 311, and a soft shackle 341 for use as a haul loop. It will be apparent to one skilled in the art that the sling loops may be connected without the use of sling paths 302 by simply connecting them to the waistbelt 301 with loops, stitching or other connections.

According to an embodiment of the present invention one or more sling paths 302 are created in the waistbelt 301, which may be situated at different locations along the waistbelt 301 to distribute weight depending on the design of the climbing harness 30. In one embodiment the sling paths 302 run parallel around waistbelt 301. In a further embodiment the sling paths 302 may run parallel or intersect depending on the preferred configuration. In one embodiment, as shown in FIG. 3, one adjustable spliced sling loop 20 is threaded through each of the one or more sling paths 302. In a further embodiment two or more adjustable spliced sling loops 20 are threaded through each of the one or more sling paths 302.

In one embodiment, the one or more adjustable spliced sling loops 20 are wrapped in the front of the sling harness 30 with a sheath to organize and protect the adjustable spliced sling loops 20 and form the waistbelt tie-in point 307. Each end of the wrap near the waistbelt 301 may be tacked into the waistbelt 301 to maintain its location along the waistbelt 301. Waistbelt tie-in loop 307 is used to connect a climbing rope, the belay loop 309, or other climbing equipment.

Belay loop 309 forms a ring that encircles the waistbelt tie-in point 307. Belay loop 309 provides an attachment point for carabiners, webbing slings, or other climbing hardware. The belay loop may be constructed of one or more individually fixed spliced loops, a single spliced loop with one or more windings, or other loop configurations. In a preferred embodiment, belay loop 309 is made from 3 individually spliced loops of ⅛th inch 12 strand braided cord woven from SK-75 fiber and spliced with a Locking Brummel Loop Splice. One spliced loop has a breaking strength of approximately 2240 lbs, Three loops then have a breaking strength of approximately 7000 lbs: thus, a three-loop belay loop 309 is stronger than most carabiners or climbing devices that would tie into the belay loop. In further embodiments the belay loop 309 may be constructed from braided cord woven from SK-78 or Liquid Crystal Polymer fiber, such as liquid crystal aromatic polyester fiber or similar braided cord.

In a further embodiment, the belay loop 309 is encased with an abrasive resistant covering. The abrasive resistant covering provides abrasion resistance and helps to form a tight, single element from the spliced loops. In further embodiments the belay loop 309 may be encased with Flexo PET tubing. According to one embodiment the Flexo PET tubing is threaded onto one or more cords, the one or more cords are then spliced into loops; wherein, the Flexo PET tubing is then trapped around the cords. In further embodiments, the belay loop may be left open or covered with other materials such as heat shrink, cloth tape, other tubing, or similar materials.

In a further embodiment of the present invention, gear loops 305 are attached to the waistbelt 301 providing a location to conveniently carry items used while climbing, such as carabiners, wired stoppers, quickdraws, a chalk bag, and the like. In a preferred embodiment, the gear loops 305 of the present invention are formed with 2 mm cord encased with Flexo PET tubing.

In a further embodiment the climbing harness 30 further comprises leg loops 321. Each leg loop 321 comprises one or more leg loop paths 325, one or more leg loop adjustable spliced loop slings 323 passing through the one or more leg loop paths 325, and a leg loop divider 329. The leg loop adjustable spliced loop slings 323 are simply shorter versions of the adjustable spliced loop slings 20 configured for use around a user's leg. The leg loop paths 325 may also be situated in different locations depending on the weight distribution needs of a particular harness design. Leg loop paths 325 may run parallel around the leg loop 321 or may intersect to provide options for distributing the weight of the user.

According to one embodiment of the present invention, the sling climbing harness 30 further includes a front leg loop link 330. In a preferred embodiment the front leg loop link 330 is constructed from 4 loops of 2 mm cord folded in half. The front leg loop link 330 forms a first end and a second end. The first end and second end of the front leg loop link 330 are each formed into a loop around a first and second leg loop thimble 333 with all strands of the front leg loop link 330 going around the first and second leg loop thimble 333. Each leg loop thimble 333 provides stability to the loop shape of each end of the front leg loop link 330 and abrasion resistance and smooth operation of the sliding motion against the leg loop adjustable spliced loop slings 323. The first and second leg loop thimbles 333 may be 3D printed, injection molded, or formed in any other manner in an appropriate plastic, nylon, or other suitable material. In a further embodiment the leg loop-end thimble 333 may be made of vinyl or other tubing, or any other suitable material.

A first and second splice wrap 335 may also be placed around the first and second end of the leg loop link 330 at the base of the leg loop thimbles 333 to prevent against wear and abrasion and protect from tampering of the splice used to form each end of the front leg loop link 330. The first and second splice wraps 335 may be heat shrink, tape, or other material to protect from abrasion and tampering of the spliced loop end. The adjustable spliced leg loop slings 323 of the first leg loop 321 pass through the first thimble 333 of the first end of the front leg loop link 330. The adjustable spliced leg loop slings 323 of the second leg loop 321 pass through the second thimble 333 of the second end of the front leg loop link.

In a further embodiment, a fabric sheath wraps the front leg loop link 330 midway between the first end and the second end of the front leg loop link 330 to form a leg loop tie-in point 331. The sheath also protects the front leg loop link 330 from abrasion from the belay loop 309, a climbing rope, and other climbing equipment. A cross-piece 332 loops through the sheath. In a further embodiment the cross-piece 332 connects to the ends of the leg loop tie-in point 331. The cross-piece forms a closed loop helping to form the leg loop tie-in point 331, which holds the belay loop 309 to maintain stability of the tension from the belay loop 309 to each leg loop 321.

In a further embodiment of the harness 30 the rear of each leg loop 321 interconnects with the soft shackle 341 on the rear of waistbelt 301 with a rear leg loop link 340. The rear adjustable leg loop link 340 has a first end and a second end. The first end of a first adjustable leg loop link 340 is connected to the first leg loop 321. The first end of a second adjustable leg loop link 340 is connected to the second leg loop 321. The second end of the first adjustable rear leg loop link 340 threads loops around the second adjustable rear leg loop link 340 over a soft shackle 341. The second end of the first rear leg loop link 340 then threads into and out of itself providing an adjustable binding section for the first second rear leg loop link 340. The second end of the second rear leg loop link 340 also threads into and out of itself providing an adjustable binding section for the second rear leg loop link 340. The first and second ends of the adjustable rear leg loop links 340 can then be adjusted by pulling or loosening to adjust the length between the waistbelt 301 and leg loops 321.

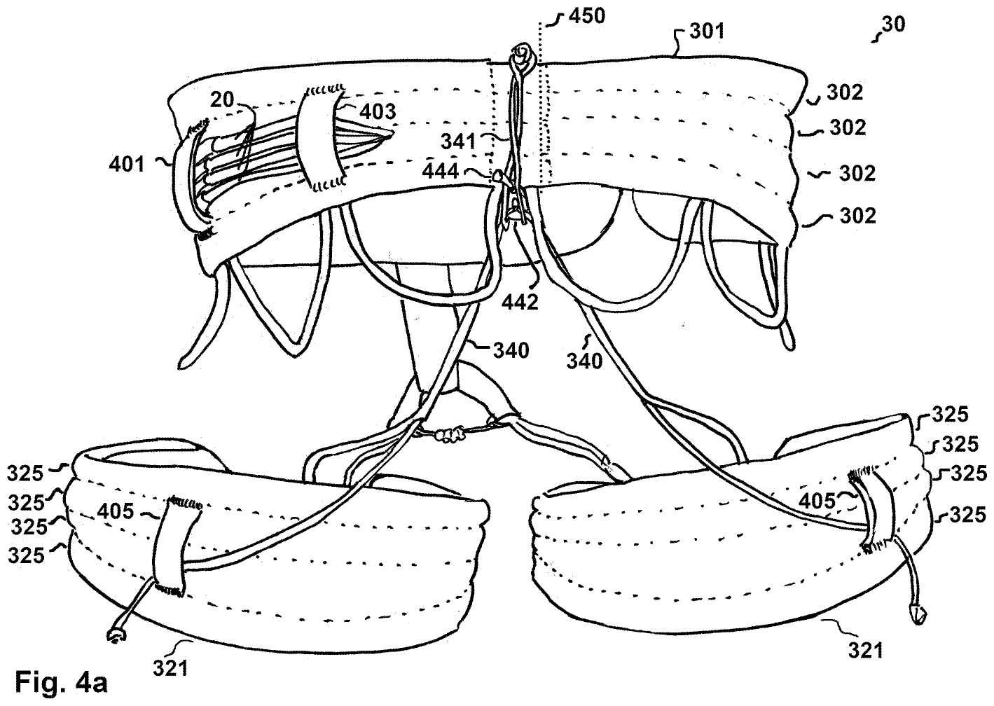

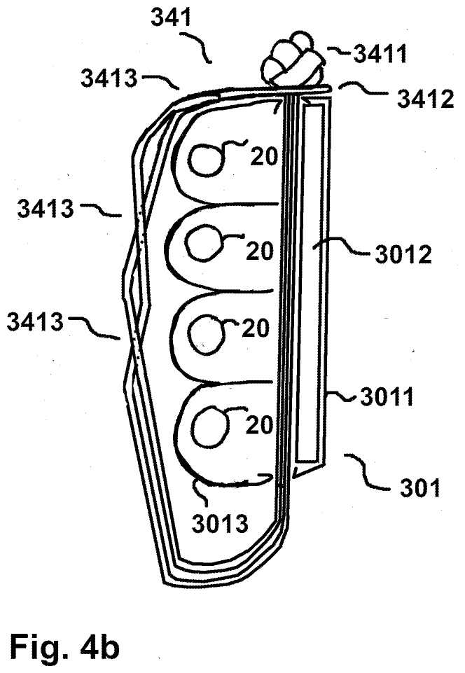

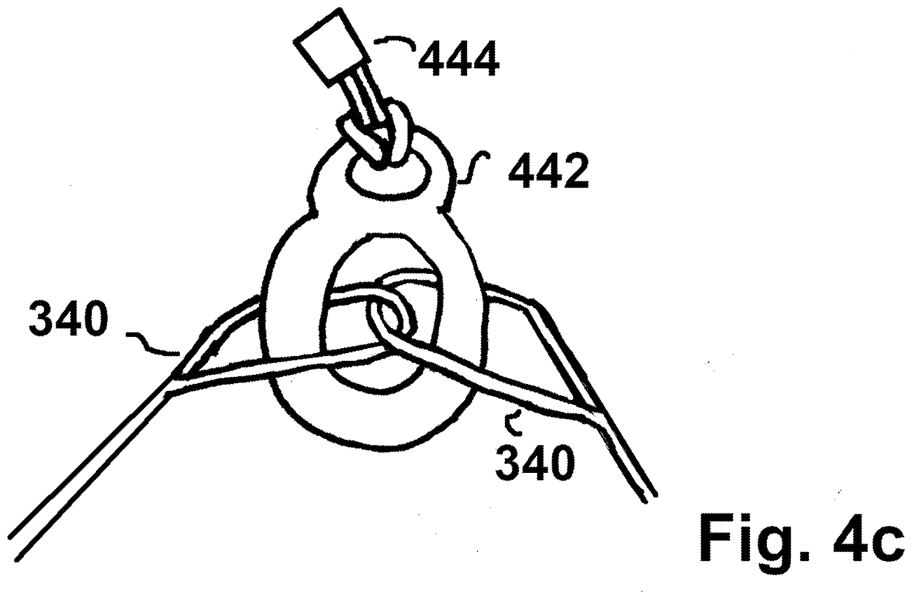

FIG. 4a shows a rear view of the sling climbing harness 30 according to an embodiment of the present invention. FIG. 4a provides further details of the waistbelt 301 and leg loops 321. In particular, FIG. 4a shows waistbelt belt loops 401 and 403. Waistbelt belt loops 401 and 403 provide a path for the ends of the adjustable spliced sling loops 20 once they are adjusted and the safety harness 30 is ready for use. Soft shackle 341 may also be used as a waistbelt belt loop to help hold the ends of the adjustable spliced sling loops 20, if needed.

FIG. 4a also provides a further view of the soft shackle 341 and the rear leg loop links 340 passing over the soft shackle 341.

FIG. 4a further provides a cross section plane 450. FIG. 4b. shows the details of the cross section of waistbelt 301. Turning to FIG. 4b, soft shackle 341 has a first end 3411 formed into a button knot, monkey fist, or similar balled-end knot. Soft shackle 341 also has a second end forming a soft shackle loop 3412. Soft shackle 341 is also threaded through itself forming one or more binding locations 3413 to assist with adjusting the soft shackle loop 3412 and providing stability to the shape of the soft shackle 341.

As shown in FIG. 4b, waistbelt 301 includes an inner layer 3011, a padding layer 3012, and an outer layer 3013. In a preferred embodiment, inner layer 3011 is made of spacer mesh. Further embodiments of the inner layer 3011 may use nylon mesh, rip-stop nylon, fleece lining, or similar materials. Padding layer 3012 is made of EVA foam in a preferred embodiment. Further embodiments of the padding layer 3012 may use other types of durable foam. In a preferred embodiment the outer layer 3013 is made from highly abrasion resistant fabric, such as Super Fabric. Further embodiments of the outer layer 3013 may be rip-stop nylon or other durable materials.

Soft shackle 341 travels inside the waistbelt 301 between the outer layer 3013 and the padding layer 3012 and loops around the outer layer 3013 of the waistbelt 301. Soft shackle second end 3412 loops over the soft shackle first end 3411 to form the soft shackle loop. As mentioned previously, the soft shackle 341 provides an additional belt loop for the tail ends of the adjustable spliced sling loops 20 of waistbelt 301.

The soft shackle 341 may also be used as a haul loop for carrying a rope or other items that are not being used by the user and are best kept out of the way of user while climbing. A climber using a haul loop of a conventional harness will attach a carabiner or other device to attach a rope or other climbing gear. The carabiner provides an simple method for disconnecting the rope or other gear when the climber is ready to detach those items. As described previously, the closed loop of the soft shackle 341 of the present invention by looping the soft shackle loop 3412 around the button knot of the second end of 3411; thus, the soft shackle 341 can be disconnected and connected. Accordingly, the soft shackle 341 may be used by the climber as a haul loop for attaching a rope or other climbing gear directly to the soft shackle 341 without the need for a carabiner or other connecting device; thus, further reducing the overall weight of the harness by eliminating unnecessary extra gear.

In one embodiment, the soft shackle 341 is made of 2 mm 12 strand braid ultra high molecular weight Polyethylene cord woven of SK-78 fiber, which has an average breaking strength of 1500 lbs. Further, the braided ultra high molecular weight Polyethylene cord used in the soft shackle 341 can hold approximately 230% of the cord strength, which makes the soft shackle have a little more than 3000 lbs of breaking strength. The soft shackle 341 wrapped around one or more adjustable spliced sling loops 20 made of ⅛th inch 12 strand braided rope of SK-75 fibers, each having approximately 2500 lbs of breaking strength provides more than sufficient strength to support the weight applied through the leg loops 321 through the rear leg loop links 340.

As shown in FIG. 4a, the soft shackle supports rear leg loop links 340 with the assistance of a link connector 442. FIG. 4c provides a detailed view of link connector 442 and its interconnection with rear leg loop links 340. Link connector 442 is similar in shape to a FIG. 8 including a first opening and a second opening. An adjustment tab 444 is tied through the first opening of the link connector 442.

A first rear leg loop link 340 has a first end and a second end. The first end of the first rear leg loop link 340 is fixed to the first leg loop 321, loops through the second opening of link connector 442, then threads into and out of itself forming a binding section in the first rear leg loop link 340. The second end of the first rear leg loop link 340 is then free for use to adjust the length of the first leg loop link 340.

A second rear leg loop link 340 has a first end and a second end. The first end of the second rear leg loop link 340 is fixed to the second leg loop 321, loops through the second opening of link connector 442 and the first rear leg loop link 340, and then threads into and out of itself forming a binding section in the second rear leg loop link 340. The second end of the second rear leg loop link 340 is then free for use to adjust the length of the second leg loop link 340.

Returning to FIG. 4a, leg loops 321 further include belt loops 405. The second ends of the first and second rear leg loop links 340 may be placed through belt loops 405 once adjusted and the sling climbing harness 30 is ready for use.

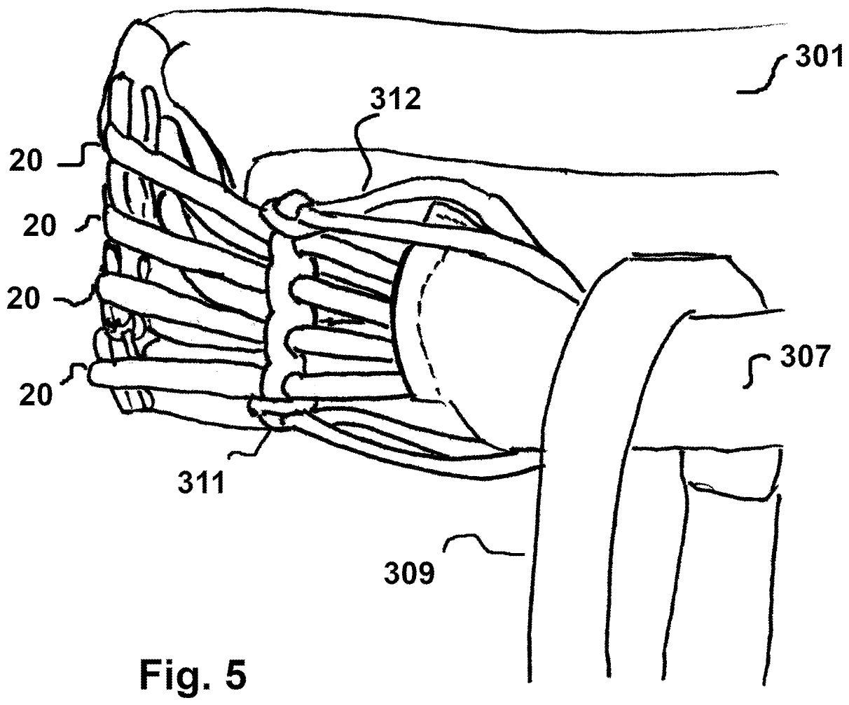

FIG. 5 shows a detailed view of the front of the waistbelt 301. The waistbelt tie-in point 307, the belay loop 309, and the sling divider 311. The wrap of the waistbelt tie-in point 307 protects the adjustable spliced sling loops 20.

Sling divider 311 is an elongated bar with one or more openings. Each adjustable spliced sling loop 20 of the waistbelt 301 is passed through one of the openings in the sling divider. Each end of the sling divider 311 also has an opening for connecting a sling handle 312. Sling handle 312 is passed around the end of the waistbelt tie-in point 307 to maintain its position. The sling divider 311 keeps the adjustable spliced sling loops 20 uniformly spread across the waistbelt 301 and allows a user to more easily loosen the adjustable spliced sling loops 20 of the waistbelt 301 when desired but doesn't compromise the strength or integrity of the adjustable spliced sling loops 20. Sling divider 311 may be 3D printed, injection molded, or formed in any other manner in an appropriate plastic, nylon, or other suitable material for wear resistance and smooth operation of the sliding motion.

Sling divider 311 is attached to the waistbelt tie-in point 307. When the sling divider 311 is pulled toward the tie-in point 307 while simultaneously pulling only the external sling cord section 221 the internal sling cord section 220 is able to slide more easily through the external sling cord section 221; thus, loosening the adjustable spliced sling loops 20 allowing the waistbelt 301 to be adjusted. This ability to loosen the adjustable spliced sling loops 20 does not create a loosening risk while climbing as the specific motion required to loosen the adjustable spliced sling loops 20 can't be replicated unintentionally while the sling climbing harness 30 is in use.

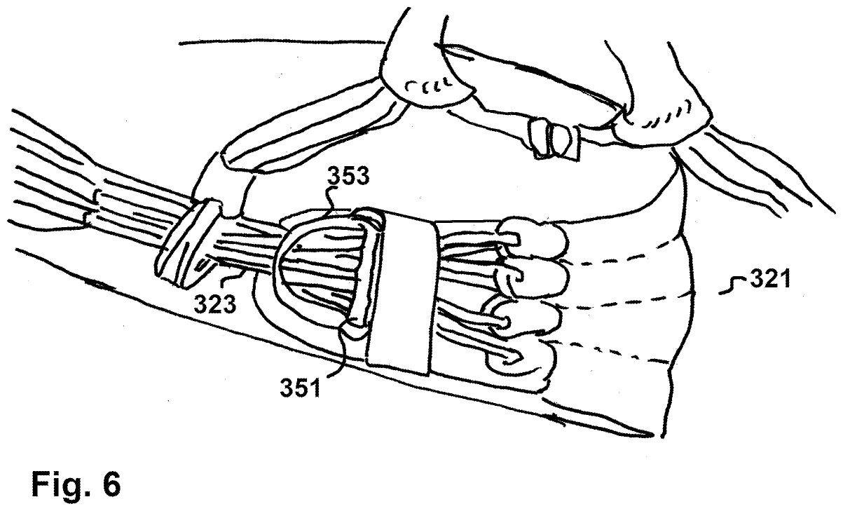

Turning to FIG. 6, a detailed view of the front of leg loop 321 is shown. In a preferred embodiment of the present invention, the leg loop 321 includes a leg loop sling divider 351, which has a similar function to that of the sling divider 311 of the waistbelt. The leg loop sling divider 351 includes openings for the leg loop adjustable spliced loop slings 323, which are simply adjustable spliced sling loops 20 that are sized for the legs. The leg loop sling divider 351 also includes an opening in each end for attaching a divider loop 353. The divider loop 353 can be pulled to slide the leg loop sling divider 351 against the outer cord 221 of the binding portion 251 of the leg loop adjustable spliced loop slings 323; thus, loosening the leg loop adjustable spliced loop slings 323 allowing the leg loop 321 to be adjusted. Sling divider 351 may be 3D printed, injection molded, or formed in any other manner in an appropriate plastic, nylon, or other suitable material for wear resistance and smooth operation of the sliding motion.

As described above, the present invention provides a lighter, safer, stronger, and more comfortable sling climbing harness 30. Decreased weight and improved comfort are obtained with the use of the adjustable spliced sling loops 20 passing through sling paths 302 in the waistbelt 301 and the adjustable spliced leg loop slings 323 through the leg loop paths 325 in the leg loops 321. The strength to weight ratio of braided cords and the preservation of that strength through the use of splicing, which maintains more strength than bar tacking webbing provides a significant reduction in the overall weight of the sling climbing harness 30.

Further, the use of adjustable spliced sling loops 20, in the waistbelt, leg loops, shoulder harnesses, or other connecting elements reduces the weight of the harness by reducing the material needed to construct the waistbelt 301 and leg loops 321, and other elements. For example, the present invention does not use nylon webbing and has no metal buckles. The adjustable spliced sling loops 20 in waistbelt 301 distribute the user's weight evenly across the wearer's back, waist, and hips. The adjustable spliced leg loop slings 323 of the leg loops 321 also allow the user to adjust the leg loops 321 for added comfort. Adjustable spliced sling loops 20, including the adjustable spliced leg loop slings 323 improve the ease of use and overall comfort as they are able to be adjusted together or individually to form to the wearer's unique body shape. The construction of the other elements of the sling climbing harness 30 also reduces the weight of the overall harness and eliminates the need for additional climbing gear typically used with a conventional climbing harness.

It will be clear to one skilled in the art that further embodiments of the present invention may include a shoulder harness, chest harness, arm loops, and the like created using adjustable spliced slings.

In summary, the sling climbing harness disclosed above provides examples that are illustrative of some of the applications of the principles of the present subject matter. Thus it is contemplated that the harness may be constructed for many different applications and alterations may be made wherein a harness may include many of the above-mentioned advantages. Further additions or alterations may be made to the harness and may be made without departing from the spirit and scope of the present disclosure. Furthermore, those skilled in the art will understand that a number of variations, including those described, may be made to the fabrics, materials, cording, plastic and other elements, and the processes for making parts of the sling climbing harness, all without departing from the scope of the invention, which is described above and defined by the appended claims.

What is claimed is:

1. A climbing harness comprising one or more adjustable spliced sling loops.

2. The climbing harness of claim 1 wherein each of the one or more adjustable spliced sling loops further comprise:
a sling cord having a first end and a second end;
the first end formed into a fixed loop; and
an adjustable loop formed by passing the second end through the fixed loop and splicing the second end through the sling cord by passing the second end into the sling cord and back out of the sling cord.

3. The climbing harness of claim 1 further comprising a waistbelt having one or more of the adjustable spliced sling loops.

4. The climbing harness of claim 1 further comprising one or more leg loops.

5. The climbing harness of claim 4 wherein the one or more leg loops are further comprised of adjustable spliced sling loops.

6. The climbing harness of claim 1 further comprising a haul loop formed with a soft shackle.

7. The climbing harness of claim 3 further comprising:
a waistbelt with a cover encasing the one or more adjustable spliced sling loops forming a waistbelt tie-in point;
a leg link loop interconnecting a first and a second leg loop forming a leg loop tie-in point; and
a belay loop interconnecting the waistbelt tie-in point and the leg loop tie-in point.

8. A climbing harness comprising one or more leg loops having one or more adjustable spliced sling loops.

9. The climbing harness of claim 8 wherein each of the one or more adjustable spliced sling loops further comprise:
a sling cord having a first end and a second end;
the first end of the sling cord forming a fixed loop;
the second end passing through the fixed loop; and
an adjustable sling loop formed by passing the second end into the sling cord and back out.

10. The climbing harness comprising a belay loop wherein the belay loop comprises one or more individually fixed spliced loops.

11. The climbing harness of claim 10 wherein the belay loop is encased with an abrasive resistant covering.
